(19) United States
(12) Patent Application Publication
(10) Pub. No.: US 2009/0195366 A1
(43) Pub. Date: Aug. 6, 2009

(54) HIGH PERFORMANCE RFID TRANSPONDER WITH FAST DOWNLINK

(75) Inventors: Herbert Meier, Moosburg (DE); Konstantin O. Aslanidis, Dachau (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND, GMBH, Freising (DE)

(21) Appl. No.: 12/253,013

(22) Filed: Oct. 16, 2008

Related U.S. Application Data
(60) Provisional application No. 61/017,015, filed on Dec. 27, 2007.

(30) Foreign Application Priority Data
Oct. 16, 2007 (DE) 10 2007 049 486.8

(51) Int. Cl. H04Q 5/22

(52) U.S. Cl. 340/10.51; 340/10.1

(57) ABSTRACT

A RFID transponder having a high quality factor antenna (LR), and a resonance capacitor (CR) coupled to the high quality factor antenna (LR) for providing a resonant circuit (LR, CR), wherein the RFID transponder is adapted to vary the quality factor of the resonant circuit (LR, CR) such that the quality factor is low during downlink data transmission when the RFID transponder receives data through the antenna (LR), and the quality factor is high during uplink data transmission, when the RFID transponder transmits data.

### CROSS REFERENCE TO RELATED APPLICATIONS

This application claims the benefit of U.S. application Ser. No. 61/017,015 filed Dec. 27, 2007, which is incorporated herein in its entirety by reference.

### FIELD OF THE INVENTION

The present invention relates to a RFID transponder, and more specifically to a RFID transponder having a resonant circuit for receiving and transmitting data.

### BACKGROUND OF THE INVENTION

For realizing high performance RFID transponder devices, which are suitable for long transmitting distances, high quality antennas are required. Typically, the high quality antennas form high quality resonant circuits together with a resonance capacitor. However, the high quality factor impairs the downlink data rate if amplitude modulation is used. If the amplitude of the downlink RF signal is changed or stopped, the oscillation amplitude is maintained for a longer time in a high quality factor resonant circuit than in a low quality factor resonant circuit. On the other hand, for passive RFID transponders, charging the transponder is more effective and feasible over greater distances if a high quality factor resonant circuit is used. Further, for uplink data transmission, when the transponder transmits data to a read/write unit (R/W unit), frequency or phase modulation is often used, which requires high quality factors, too.

### SUMMARY OF THE INVENTION

It is a general object of the present invention to provide an RFID transponder which is capable of transmitting and receiving data efficiently during both uplink and downlink data transmission.

An RFID transponder is provided, which includes a high quality factor antenna, and a resonance capacitor coupled to the high quality factor antenna for providing a resonant circuit. The RFID transponder is adapted to vary the quality factor of the resonant circuit such that the quality factor is low during downlink data transmission when the RFID transponder receives data through the antenna and such that the quality factor is high during uplink data transmission, when the RFID transponder transmits data. For example, for amplitude modulation used for downlink data transmission, a low quality factor allows much higher data rates to be achieved than a high quality factor. On the other hand, for uplink data transmission, often a frequency modulation (FM) is used, which requires a high quality factor. The RFID transponder according to an aspect of the present invention is therefore adapted to be switched between a high quality factor and a low quality factor of the resonant circuit that includes the high quality, typically inductive, antenna.

Further, the RFID transponder can be adapted to have a high quality factor also during a charging phase, when the RFID transponder is charged by an electromagnetic wave received through the antenna. A high quality factor allows the RFID transponder to be charged more efficiently and over larger distances than a low quality factor. Therefore, the RFID transponder according to an aspect of the present invention is preferably adapted to be switched into a high quality factor mode during the charging phase. This implies, however, that for passive transponders, which are supplied exclusively by electromagnetic waves, the quality factor is to be set to a high value during initialization.

In order to switch the quality factor of the resonant circuit between a high quality factor and a low quality factor, according to an aspect of the invention, a series of a damping capacitor and a damping resistor can be switched in parallel to the resonant circuit. Therefore, a switch can be coupled in series to the damping capacitor and the damping resistor, in order to selectively switch the series of damping capacitor and damping resistor on and off, i.e. in parallel configuration to the resonant circuit for damping. Actually, the serial combination of damping resistor and capacitor can be connected to the resonant circuit (i.e. to a node at which the capacitor and the inductor are connected) and to ground via a switch in order to reduce the quality factor. A series of a damping capacitor and a damping resistor is more power efficient than a sole damping resistor. If the series of damping capacitor and damping resistor is coupled to the resonant circuit, the resonant circuit has a low quality factor. Without having the series of damping capacitor and damping resistor coupled to the resonant circuit and to ground, the resonant circuit has a high quality factor.

In order to handle signals received with a high and with a low quality factor, according to an aspect of the invention, a demodulation stage must be provided, which is adapted to demodulate a downlink signal received with a high quality factor of the resonant circuit and to demodulate a downlink signal received with a low quality factor of the resonant circuit as well. A low quality factor of the resonant circuit results in a reduced amplitude of the received electromagnetic wave. Dependent on the specific configuration of the RFID transponder front end, the detection levels or reference levels, which are used to determine whether or not an external RF signal is present, should be adjustable to allow quick and reliable detection of the RF signal. A higher data rate during downlink can be achieved with a resonant circuit having a low quality factor, since the oscillation of the resonant circuit decreases quicker than with a high quality factor when the external excitation stops. However, the demodulation stage or end of burst (EOB) stage must also be adapted to take account of the smaller amplitudes of the received signal due to the low quality factor. Preferably, the demodulation stage has a self-adjusting reference level, which is adapted in accordance with the chosen quality factor. The demodulation stage is preferably adapted to detect OFF periods of a received RF signal when the RFID transponder is set to a low quality factor. As these OFF periods can be shorter than with a RFID transponder having a constant quality factor, the internal timing setup must be adjustable to a change of quality factors. A demodulation stage (or end of burst stage) according to the present invention is adapted to take account of the change of quality factor and the related different timing.

The demodulation stage of the RFID transponder according to an aspect of the present invention can as well be implemented as two demodulation stages rather than a single stage. A first demodulation stage can then be adapted to detect an end of burst of a RF signal received with a high quality factor and a second demodulation stage can be adapted to detect an end of burst of a RF signal received with a low quality factor.

Also, a start-stop stage may be provided in the RFID transponder, which is adapted to start an oscillation maintenance stage to maintain the resonant circuit oscillation when the quality factor is high and when the end of burst stage has detected the absence of a burst of a received RF signal (i.e. during OFF periods but in high Q mode). Furthermore, during uplink data transmission the start-stop stage starts the oscillation maintenance stage. Generally, the oscillation maintenance stage can use the resonant circuit as an oscillator during OFF periods and provides a respective internal excitation of the resonant circuit. This maintained oscillation of the resonant circuit can then be used as a basis for a reference clock, while the external RF signal is absent. The present invention provides that the oscillation maintenance circuit is switched off (i.e. it is not used) during Low Q mode so that the OFF periods, where the external RF excitation is absent, become short and stable and the overall power consumption in the RFID transponder is reduced. Further, since the OFF periods can be very short, none or only a few clock cycles can get lost, even without an internal reference clock. Therefore, the present invention provides further that the information, i.e. the difference between a high bit and low bit, is coded in the different lengths of the respective ON periods. Since the OFF periods have the same lengths and the lengths of the ON periods vary, the ratio ON to OFF can be chosen such that a loss of only a few clock cycles during an OFF period is not relevant for the determination of the received data bits (i.e. for the decision whether the bit was high or low).

According to another aspect of the invention, the clock of an extra internal oscillator can be used in low Q mode instead of using the RF related clock, i.e. instead of using the oscillation maintenance stage. The extra internal oscillator (or reference clock) has to be calibrated either during production or automatically using low and high reference bits at start of data transmission.

A RFID system according to an aspect of the present invention comprises a R/W-unit and a RFID transponder. The RFID transponder is implemented according to the aspects as set out before. Accordingly, the RFID transponder has a high quality factor antenna, and a resonance capacitor coupled with the high quality factor antenna for providing a resonant circuit. The RFID transponder is adapted to vary the quality factor of the resonant circuit such that the quality factor is low during downlink data transmission when the RFID transponder receives data through the antenna, and the quality factor is high during uplink data transmission, when the RFID transponder transmits data. The R/W-unit is adapted to transmit data during downlink data transmission with an increased data rate. In particular, the R/W-unit is adapted to profit from the reduced OFF periods, which can be used in a downlink burst modulation, when the RFID transponder has a low quality factor of the resonant circuit.

The present invention relates also to a R/W-unit, which is adapted to communicate with a RFID transponder, which can adjust the quality factor of the resonant circuit in accordance with the above aspects of the invention. Therefore, the present invention also provides a data protocol for downlink data communication that profits from the increased data rate, which can be used for a RFID transponder that can switch the quality factor of the resonant circuit to a lower value during downlink data transmission.

The present invention relates also to a method for operating an RFID transponder. Accordingly, a resonant circuit of the RFID transponder for receiving and transmitting an RF signal is switched to a low quality factor during downlink data transmission and to a high quality factor during uplink data transmission. Further, the RFID transponder, or rather the resonant circuit in the RFID transponder, is switched to a high quality factor during a charging phase, in which the RFID transponder is charged by use of an external RF signal.

### BRIEF DESCRIPTION OF THE DRAWINGS

Further aspects of the present invention will ensue from the description hereinbelow of the preferred embodiment of the present invention with reference to the accompanying drawings, in which:

FIG. 1 shows a simplified circuit diagram of an RFID transponder front end according to the present invention, and

FIG. 2 shows waveforms relating to downlink and uplink data transmission of an RFID transponder according to the present invention.

### DETAILED DESCRIPTION OF THE INVENTION

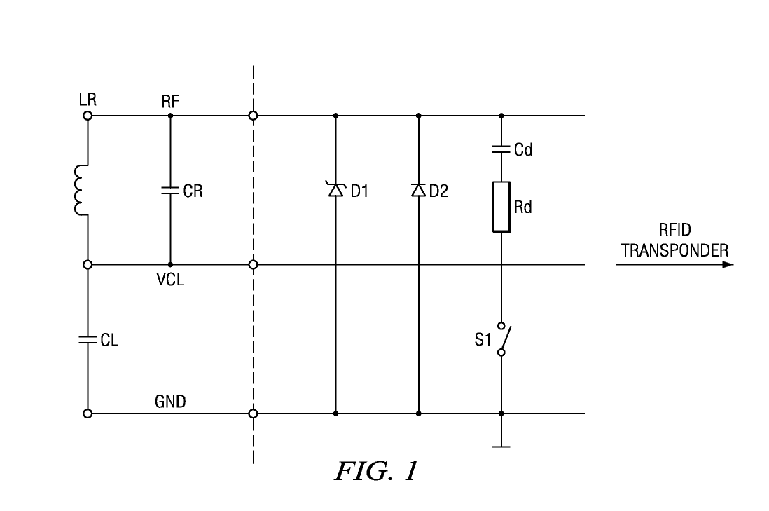

FIG. 1 shows a simplified circuit diagram of a front end of an RFID transponder according to the present invention. A high quality antenna LR is coupled in parallel to a resonance capacitance CR. The resonant circuit LR, CR is coupled with one side to a buffer capacitance CL, which is to be charged during a charging phase of the transponder. The internal supply voltage is then VCL. Diodes D1 and D2 serve as a single-side rectifier for the received oscillation. The diode D1 additionally limits the RF oscillation amplitude and therefore the supply voltage VCL to a value acceptable for the supplied circuitries. An external RF signal is received through the high quality antenna LR and triggers the resonant circuit LR, CR to oscillate at the resonant frequency. Diodes D1, D2 serve as rectifying means using the RF signal received through the antenna LR for charging the buffer capacitance CL and thereby node VCL to a constant voltage level, which is used as internal supply voltage for the RFID transponder.

According to the present invention, a damping capacitor Cd and a damping resistor Rd are connected in series. The series of the damping capacitor and the damping resistor can be coupled in parallel to the resonant circuit through a switch S1 for decreasing the quality factor of the resonant circuit LR, CR. If switch S1 is closed (i.e. the switch is conductive), the series of capacitor Cd and resistor Rd are coupled in parallel to the resonant circuit and the buffer capacitor CL. The quality factor of the resonant circuit is then low. If switch S1 is open (i.e. the switch is not conductive), the quality factor of the resonant circuit LR, CR remains unchanged and as high as provided for by its components.

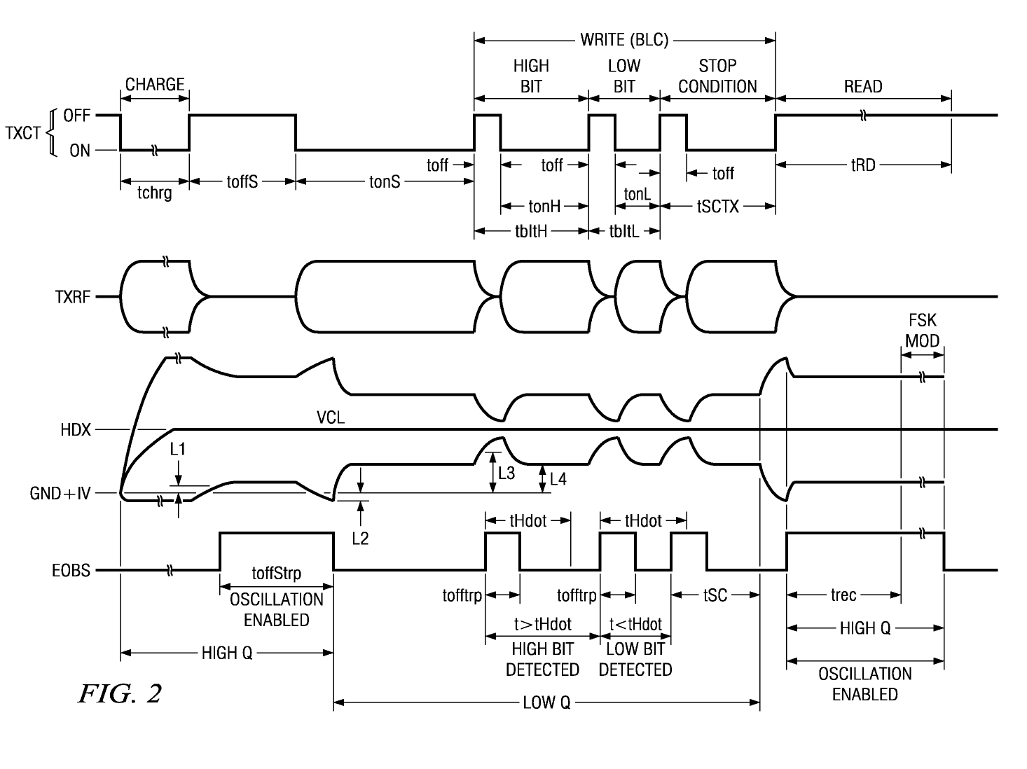

The operation and several internal signals of the transponder according to the invention are explained with respect to FIG. 2. FIG. 2 shows waveforms of numerous signals of the RFID transponder according to the present invention. The signals shown in FIG. 2 relate to a communication scheme between a R/W-unit and the RFID transponder according to the present invention.

There is an RF module TXCT-signal, which shows in a digital representation the ON and OFF periods of the R/W-unit, i.e. when the RF signal at the R/W used for downlink is switched ON and when it is switched OFF. The HIGH level corresponds to an OFF period and a LOW level corresponds to an ON period. Below the TXCT signal there is the transmitter RF signal TXRF from the R/W-unit. The transmitter RF signal TXRF is represented by its envelope signal, as the oscillation frequency of the transmitter RF signal TXRF is too high to be represented in the time scale of FIG. 2. If TXCT is low (ON), the TXRF signal oscillates.

The transponder RF signal HDX is shown below the transmitter RF signal TXRF. The transponder RF signal HDX is the signal at (i.e. the voltage drop across) the resonant circuit (LR, CR in FIG. 1). HDX is also represented by its envelope signal.

The end of burst signal EOBS of the internal demodulation stage (or end of burst stage EOB) is indicated. The end of burst signal EOBS has multiple functions. It represents the data in a digital (i.e. demodulated) manner as it is received from the R/W-unit. On the other hand, the end of burst signal EOBS is an important internal control signal, which can be used to coordinate internal functions, as for example the use of the internal oscillator. If EOBS goes high, this indicates that the external oscillation signal TXRF has stopped, and that the internal clock or maintenance oscillator can be started to have a time reference for measuring out the length of the period without an external signal TXRF. The end of burst signal EOBS in combination with any internal control mechanisms is also important for controlling the switching of the resonant circuit to a high quality factor (high Q) or a low quality factor (low Q).

On the bottom of FIG. 2, the high Q and the low Q periods are indicated, where Q relates to the quality factor of the resonant circuit LR, CR (shown in FIG. 1). During a low Q period LowQ, the series of damping resistor Rd and damping capacitor Cd are coupled to the resonant circuit LR, CR. In a high Q period HighQ the damping components Rd, Cd are switched off.

The data transmission starts with a charging period CHARGE, which is issued by the R/W-unit and has a length of tchrg. During this charging phase the TXRF signal is activated for a period that is long enough to charge the RFID transponder. Accordingly, in the RFID transponder, the internal supply voltage VCL is generated. This is indicated by line VCL within the transponder RF signal HDX. As soon as the received RF signal HDX exceeds with its lower limit a specific minimum voltage GND+1V, the end of burst stage EOB detects that the external oscillation has stopped and the end of burst signal EOBS goes high. When EOBS goes high, the internal oscillation maintenance stage is enabled by the start-stop stage as indicated within the high period of the end of burst signal EOBS. During the charging phase, i.e. during a time tchrg and during the following period toffStrp, the resonant circuit has a high quality factor indicated by HighQ. After having charged the capacitor CL (shown in FIG. 1) by a charge burst, the transmitter (R/W unit) switches off for a relatively long period toffS/toffStrp (e.g. approximately 300 μs), so that the oscillation of the high Q resonant circuit LR, CR can drop sufficiently to allow the EOB detector to recognize the drop. The exact limit, where the end of burst signal EOBS goes high, is a little higher than GND+1V, due to a hysteresis. The EOB demodulation stage activates an internal clock in order to have an internal time reference clock signal for the internal logic. The internal logic will determine the duration of the pulse during which the end of burst signal EOBS is high (i.e. toffStrp). This allows a charge-only RFID transponder type to be distinguished from a read/write RFID transponder type. A read/write RFID transponder needs a specific downlink protocol. If the time period toffS is longer than a specific amount of time (e.g. 256 clock cycles of the internal maintenance clock), a charge-only transponder is detected. The uplink modulation will then start within a specific time, e.g. 1.9 ms for a 134.2 kHz oscillation frequency. If the duration of toffS is shorter, which is the alternative shown in FIG. 2, a downlink transmission is expected and the RFID transponder switches the serial connection of damping resistor Rd and damping capacitor Cd in parallel to the resonant circuit LR, CR (including CL). The end of burst signal EOBS goes low. Now, the resonant circuit LR, CR has a reduced quality factor. Due to this low quality factor, the RF amplitude of the transponder RF signal HDX drops more quickly when the transmitter RF signal TXRF stops. This is shown within the WRITE cycle indicated on the top of FIG. 2. After a period of time tonS (refer to TXCT signal), the transmitter can switch to a high speed downlink protocol using burst length modulation (indicated in FIG. 2 by BLC). Accordingly, the transmission bursts are varied in length in order to distinguish between high and low bit transmission. The demodulation of the downlink burst length modulated signal will be performed by the end of burst demodulation stage EOB. For this purpose, the EOB stage preferably has a self-adjusting reference level, and optionally an automatic gain control amplifier (AGC). As shown in the HDX signal waveform, in a high Q period HighQ, the upper reference level L1 and the lower reference level L2 are set around GND+1V. If HDX raises above L1 in a high Q period, the EOB stage detects that the external oscillation has stopped (TXRF is off) and the end of burst signal EOBS is set high. If HDX drops below L2, the EOB stage detects that TXRF has resumed oscillating and EOBS goes low. However, during a low Q period LowQ, the oscillation amplitude of the HDX signal is smaller, and the negative amplitudes will not reach the voltage level of GND+1V. Therefore, new limits L3 and L4 have to be set for detecting whether a burst of the TXRF signal is present or not. Accordingly, the EOB stage should be adapted to adjust its reference levels or two different EOB stages must be used. The difference of L1 with respect to L2 and of L3 with respect to L4 is due to hysteresis.

A high bit (HIGH BIT sequence in TXCT) and a low bit (LOW BIT sequence) have the same length of the OFF periods toff. This OFF period can be kept very short as the RFID transponder is in low Q mode and oscillation maintenance is not activated. In low Q mode LowQ, the oscillation dies out quicker than in high Q mode HighQ. The ON periods tonH (for HIGH BIT) and tonL (for LOW BIT) are different and so are the overall time periods tbitH and tbitL for high and low bits. This difference is used in the RFID transponder to distinguish between high bits and low bits, as it is indicated in the end of bust signal EOBS. If the period between two end of burst signals EOBS is equal to or longer than tHdet (t>tHdet), a high bit is detected. If the period between two end of burst signals EOBS is shorter than tHdet (t<tHdet), a low bit is detected. The data rate during downlink transmission can be increased, if the Q of a transponder is decreased compared with a RFID transponder having an unchanged quality factor of its internal oscillator LR, CR.

The downlink data transmission is finished with a specific stop condition (toff, tSCTX). This results in a deactivation of the damping circuit and the resonant circuit is set to high Q. Further, the start-stop stage enables and starts the internal oscillation maintenance stage after the time tSC. Since the time tSC is chosen to be shorter than tSCTX, the buffer capacitor CL will be recharged and so some energy consumed during downlink can be recovered. The response amplitude will therefore again be high during uplink. The uplink period is indicated by READ on the top of FIG. 2. The READ period lasts for a time tRD and starts with a recovery time of a period trec. The period trec is needed by the R/W-unit to recover from the power burst. After trec, the uplink data transmission from the RFID transponder to the R/W-unit starts. For uplink, a frequency shift keying (FSK) modulation is used that needs a high quality factor HighQ.

Although aspects of the present invention are particularly advantageous for battery-less RFID transponders, some or all aspects of the present invention are also applicable to RFID transponders having a battery or any other internal power supply.

Although the present invention has been described with reference to a specific embodiment, it is not limited to this embodiment and no doubt alternatives will occur to the skilled person that lie within the scope of the invention as claimed.

1. A RFID transponder comprising:
a high quality factor antenna (LR);
a resonance capacitor (CR) coupled to the high quality factor antenna (LR) for providing a resonant circuit (LR, CR), wherein the RFID transponder is adapted to vary the quality factor of the resonant circuit (LR, CR) such that the quality factor is low during downlink data transmission when the RFID transponder receives data through the antenna (LR), and the quality factor is high during uplink data transmission, when the RFID transponder transmits data.

2. The RFID transponder according to claim 1, wherein the RFID transponder is adapted to have the high quality factor during a charging phase, when the RFID transponder is charged by an electromagnetic wave received through the antenna (LR).

3. The RFID transponder according to claim 1, further comprising a demodulation stage (EOB) adapted to detect an end of burst of a RF signal received using the high quality factor and adapted to detect an end of burst received using the low quality factor.

4. The RFID transponder according to claim 1, further comprising a first demodulation stage adapted to detect an end of burst of a RF signal received using the high quality factor and a second demodulation stage adapted to detect an end of burst of a RF signal received using the low quality factor.

5. The RFID transponder according to claim 3, wherein the demodulation stage (EOB) is adapted to self-adjust a reference level used for detecting ends of bursts of a received RF signal in response to a change of the quality factor.

6. The RFID transponder according to claim 5, wherein the demodulation stage (EOB) is adapted to detect OFF periods of a received RF signal when the RFID transponder is set to the low quality factor.

7. The RFID transponder according to claim 1, further comprising a damping capacitor (Cd), a damping resistor (Rd) and a switch (S1) all coupled in series for switching the series of the damping capacitor (Cd) and the damping resistor (Rd) in parallel to the resonant circuit (LR, CR) in order to selectively reduce or maintain the quality factor of the resonant circuit (LR, CR).

8. The RFID transponder according to claim 1, further comprising a start-stop stage which is adapted to start an oscillation maintenance stage to maintain the resonant circuit oscillation only when the quality factor is high and when the end of burst stage has detected an end of burst of a received RF signal, and to start the oscillation maintenance stage during uplink data transmission.

9. A RFID system having a R/W-unit and a RFID transponder, the transponder comprising:
a high quality factor antenna (LR);
a resonance capacitor (CR) coupled to the high quality factor antenna (LR) for providing a resonant circuit (LR, CR), wherein the RFID transponder is adapted to vary the quality factor of the resonant circuit (LR, CR) such that the quality factor is low during downlink data transmission when the RFID transponder receives data through the antenna (LR), and the quality factor is high during uplink data transmission, when the RFID transponder transmits data, and wherein the R/W-unit is adapted to transmit data during downlink data transmission with reduced OFF periods, when the RFID transponder has a low quality factor of the resonant circuit.

10. A R/W-unit to be used with a RFID transponder comprising:
means to change the quality factor of its resonant circuit between uplink data transmission and downlink data transmission, wherein the R/W-unit comprises means to transmit data during downlink data transmission with reduced OFF periods, when the RFID transponder has switched to a low quality factor of the resonant circuit.

11. A method for operating a RFID transponder, the method comprising:
switching a resonant circuit of the RFID transponder for receiving and transmitting an RF signal to a low quality factor during downlink data transmission; and
Switching to a high quality factor during uplink data transmission.

12. The method according to claim 11, further comprising switching to the high quality factor during a charging phase, in which the RFID transponder is charged by use of an RF signal.

13. The RFID transponder according to claim 2, further comprising a demodulation stage (EOB) adapted to detect an end of burst of a RF signal received using the high quality factor and adapted to detect an end of burst received using the low quality factor.

14. The RFID transponder according to claim 2, further comprising a first demodulation stage adapted to detect an end of burst of a RF signal received using the high quality factor and a second demodulation stage adapted to detect an end of burst of a RF signal received using the low quality factor.

15. The RFID transponder according to claim 2, further comprising a damping capacitor (Cd), a damping resistor (Rd) and a switch (S1) all coupled in series for switching the series of the damping capacitor (Cd) and the damping resistor (Rd) in parallel to the resonant circuit (LR, CR) in order to selectively reduce or maintain the quality factor of the resonant circuit (LR, CR).

16. The RFID transponder according to claim 3, further comprising a damping capacitor (Cd), a damping resistor (Rd) and a switch (S1) all coupled in series for switching the series of the damping capacitor (Cd) and the damping resistor (Rd) in parallel to the resonant circuit (LR, CR) in order to selectively reduce or maintain the quality factor of the resonant circuit (LR, CR).

17. The RFID transponder according to claim 4, further comprising a damping capacitor (Cd), a damping resistor (Rd) and a switch (S1) all coupled in series for switching the series of the damping capacitor (Cd) and the damping resistor (Rd) in parallel to the resonant circuit (LR, CR) in order to selectively reduce or maintain the quality factor of the resonant circuit (LR, CR).

18. The RFID transponder according to claim 5, further comprising a damping capacitor (Cd), a damping resistor (Rd) and a switch (S1) all coupled in series for switching the series of the damping capacitor (Cd) and the damping resistor (Rd) in parallel to the resonant circuit (LR, CR) in order to selectively reduce or maintain the quality factor of the resonant circuit (LR, CR).

19. The RFID transponder according to claim 6, further comprising a damping capacitor (Cd), a damping resistor (Rd) and a switch (S1) all coupled in series for switching the series of the damping capacitor (Cd) and the damping resistor (Rd) in parallel to the resonant circuit (LR, CR) in order to selectively reduce or maintain the quality factor of the resonant circuit (LR, CR).

20. The RFID transponder according to claim 2, further comprising a start-stop stage which is adapted to start an oscillation maintenance stage to maintain the resonant circuit oscillation only when the quality factor is high and when the end of burst stage has detected an end of burst of a received RF signal, and to start the oscillation maintenance stage during uplink data transmission.
